(19) United States
(12) Patent Application Publication
(10) Pub. No.: US 2013/0189588 A1
(43) Pub. Date: Jul. 25, 2013

(54) METHOD FOR PRODUCING SOLID ELECTROLYTE MEMBRANE

(71) Applicants: Chihiro YADA, Susono-shi (JP); Brian Elliott HAYDEN, Lyndhurst (GB); Duncan Clifford Alan SMITH, Southampton (GB); Christopher Edward LEE, Southampton (GB)

(72) Inventors: Chihiro YADA, Susono-shi (JP); Brian Elliott HAYDEN, Lyndhurst (GB); Duncan Clifford Alan SMITH, Southampton (GB); Christopher Edward LEE, Southampton (GB)

(73) Assignee: TOYOTA JIDOSHA KABUSHIKI KAISHA, Toyota-shi (JP)

(21) Appl. No.: 13/449,964

(22) Filed: Apr. 18, 2012

(30) Foreign Application Priority Data
Jan. 25, 2012 (JP) 2012-013049

(51) Int. Cl. H01M 10/0562

(52) U.S. Cl. 429/305; 429/322

(57) ABSTRACT

An object of the present invention is to provide a solid electrolyte membrane which comprises Li₃ₓLa_{2/3-x}TiO₃ (0.05≦x≦0.17) and has excellent ion conductivity. Disclosed is a method for producing a solid electrolyte membrane which comprises a solid electrolyte described by the composition formula Li₃ₓLa_{2/3-x}TiO₃ (0.05≦x≦0.17), the method comprising the steps of: producing a gas phase material comprising lithium, lanthanum and titanium by converting into a gas phase at least one selected from the group consisting of a lithium metal, a lanthanum metal, a titanium metal, a lithium-lanthanum alloy, a lithium-titanium alloy, a lanthanum-titanium alloy and a lithium-lanthanum-titanium alloy, and depositing an Li₃ₓLa_{2/3-x}TiO₃ (0.05≦x≦0.17) thin film on a substrate by a gas phase method for reacting the gas phase material with oxygen in a single element state.

### TECHNICAL FIELD

The present invention relates to a method for producing a solid electrolyte membrane.

### BACKGROUND ART

In recent years, with the rapid spread of IT- and communication-related devices such as personal computers, camcorders and cellular phones, much attention has been focused on the development of batteries which are used as their power sources. Also in the automobile industry, high-power and high-capacity batteries for electric vehicles and hybrid vehicles are under development. Among various kinds of batteries, a lithium battery is drawing attention due to its high energy density and high power output.

In general, a lithium battery comprises a positive electrode active material layer comprising a positive electrode active material, a negative electrode active material layer comprising a negative electrode active material, and an electrolyte layer present between the positive and negative electrode active material layers. In addition, as needed, it comprises a positive electrode current collector for collecting current from the positive electrode active material layer and a negative electrode current collector for collecting current from the negative electrode active material layer.

A lithium battery in which a combustible organic electrolytic solution is used as the electrolyte layer that is present between the positive and negative electrode active material layers, has to have safety measures against leakage, short circuit, overcharge, etc. A further improvement in safety is required, especially for a high-power, high-capacity battery. Therefore, research and development of all-solid-state batteries have been promoted, such as an all-solid-state lithium secondary battery using a solid electrolyte membrane such as a sulfide- or oxide-based solid electrolyte membrane as the electrolyte layer.

In an all-solid-state battery, examples of the method for producing a solid electrolyte membrane include a method for pressure-forming solid electrolyte particles and a method for depositing a thin film by a gas phase method using an oxide as a vapor deposition material.

As the thin film deposition method, Patent Literature 1 discloses a method for producing a solid electrolyte membrane by a pulsed laser method using an oxide comprising La, Li and Ti as the evaporation source, the membrane having the composition of LaₓLi_{y}Ti_{z}O₃ (wherein 0.4≦X≦0.6, 0.4≦Y≦0.6, 0.8≦Z≦1.2 and Y<X) and a non-crystalline structure.

### CITATION LIST

Patent Literature 1: Japanese Patent Application Laid-Open No. 2009-238704

### SUMMARY OF INVENTION

### Technical Problem

Due to its high ion conductivity, Li₃ₓLa_{2/3-x}TiO₃ (0.05≦x≦0.17) is a promising material for solid electrolyte membranes. However, when formed into a thin film, it is problematic in that high ion conductivity is not obtained. Especially, a crystalline thin film of Li₃ₓLa_{2/3-x}TiO₃, which has high ion conductivity, is difficult to produce by a conventional method for pressure-molding solid electrolyte particles or by a conventional gas-phase thin film deposition method.

For example, in the case of the gas-phase thin film deposition method as disclosed in Patent Literature 1, which uses an oxide as the target, a slight amount of impurities remaining in the target, such as Li₂CO₃, get mixed into the thin film and gas such as CO₂ is produced when heating the thin film to obtain a crystalline thin film, thereby forming holes in the resulting crystalline thin film. Due to the holes thus formed, the ion conductivity of the thin film is decreased.

Furthermore, in the gas-phase thin film deposition method using an oxide as the target, an oxide target is needed to be prepared, and thus the method has a problem of low productivity.

Also, the solid electrolyte membrane disclosed in Patent Literature 1 is characterized by having a non-crystalline structure. However, in the battery production, for the purpose of crystallization of electrode active materials, a laminate of a solid electrolyte membrane and an electrode active material layer may be treated at high temperature. As a result of high temperature treatment, the non-crystalline solid electrolyte membrane is also crystallized, so that there is a need for a solid electrolyte membrane which exists stably in a crystalline state and has high ion conductivity.

The present invention was achieved in light of the above circumstances. An object of the present invention is to provide a solid electrolyte membrane which comprises Li₃ₓLa_{2/3-x}TiO₃ (0.05≦x≦0.17) and has excellent ion conductivity.

### Solution to Problem

The method for producing a solid electrolyte membrane of the present invention is a method for producing a solid electrolyte membrane, which comprises a solid electrolyte described by the composition formula Li₃ₓLa_{2/3-x}TiO₃ (0.05≦x≦0.17), the method comprising the steps of: producing a gas phase material comprising lithium, lanthanum and titanium by converting into a gas phase at least one selected from the group consisting of a lithium metal, a lanthanum metal, a titanium metal, a lithium-lanthanum alloy, a lithium-titanium alloy, a lanthanum-titanium alloy and a lithium-lanthanum-titanium alloy, and depositing an Li₃ₓLa_{2/3-x}TiO₃ (0.05≦x≦0.17) thin film on a substrate by a gas phase method for reacting the gas phase material with oxygen in a single element state.

According to the present invention, it is possible to produce a solid electrolyte membrane with excellent ion conductivity, especially excellent lithium ion conductivity.

Preferably, the substrate is heated at a temperature lower than the melting point of lanthanum and that of titanium in the deposition step. This is because it is thus possible to increase the density of the solid electrolyte membrane and to further increase the ion conductivity of the same.

Preferably, the method for producing a solid electrolyte membrane of the present invention further comprises a step of heating the Li₃ₓLa_{2/3-x}TiO₃ thin film after the deposition step. This is because it is thus possible to accelerate the crystallization of Li₃ₓLa_{2/3-x}TiO₃.

In the heating step, the Li₃ₓLa_{2/3-x}TiO₃ thin film can be heated at, for example, 500 to 1,000° C.

In the gas phase material production step, for example, the lithium metal, lanthanum metal and titanium metal can be each separately converted into a gas phase to produce lithium, lanthanum and titanium in gas phase states.

In this case, the lithium, lanthanum and the titanium in gas phase states are reacted with the oxygen in a single element state in the deposition step.

As the oxygen in a single element state in the deposition step, there may be mentioned is oxygen plasma.

### Advantageous Effects of Invention

According to the present invention, it is possible to produce a solid electrolyte membrane which comprises Li₃ₓLa_{2/3-x}TiO₃ (0.05≦x≦0.17) and has excellent ion conductivity. It is also possible to produce a crystalline solid electrolyte membrane, so that the solid electrolyte membrane provided by the present invention can show stable ion conductivity after the production of a battery.

### BRIEF DESCRIPTION OF DRAWINGS

FIG. 1 is a view schematically showing an embodiment of the present invention.

FIG. 2 is a TEM photograph of Example 1.

FIG. 3 is a TEM photograph of Example 1.

FIG. 4 is an SEM photograph of Comparative Example 1.

FIG. 5 is a TEM photograph of Comparative Example 1.

### DESCRIPTION OF EMBODIMENTS

The method for producing a solid electrolyte membrane of the present invention is a method for producing a solid electrolyte membrane, which comprises a solid electrolyte described by the composition formula Li₃ₓLa_{2/3-x}TiO₃ (0.05≦x≦0.17), the method comprising the steps of: producing a gas phase material comprising lithium, lanthanum and titanium by converting into a gas phase at least one selected from the group consisting of a lithium metal, a lanthanum metal, a titanium metal, a lithium-lanthanum alloy, a lithium-titanium alloy, a lanthanum-titanium alloy and a lithium-lanthanum-titanium alloy, and depositing an Li₃ₓLa_{2/3-x}TiO₃ (0.05≦x≦0.17) thin film on a substrate by a gas phase method for reacting the gas phase material with oxygen in a single element state.

The present invention relates to a method for depositing the Li₃ₓLa_{2/3-x}TiO₃ thin film by a gas phase method. In the present invention, the deposition of a thin film by a gas phase method means the formation of a thin film by converting a vapor deposition material (material for a thin film) into a gas phase under vacuum condition and depositing the resultant on a substrate. Specific thin film forming methods include physical vapor deposition methods such as vacuum deposition, sputtering and ion plating.

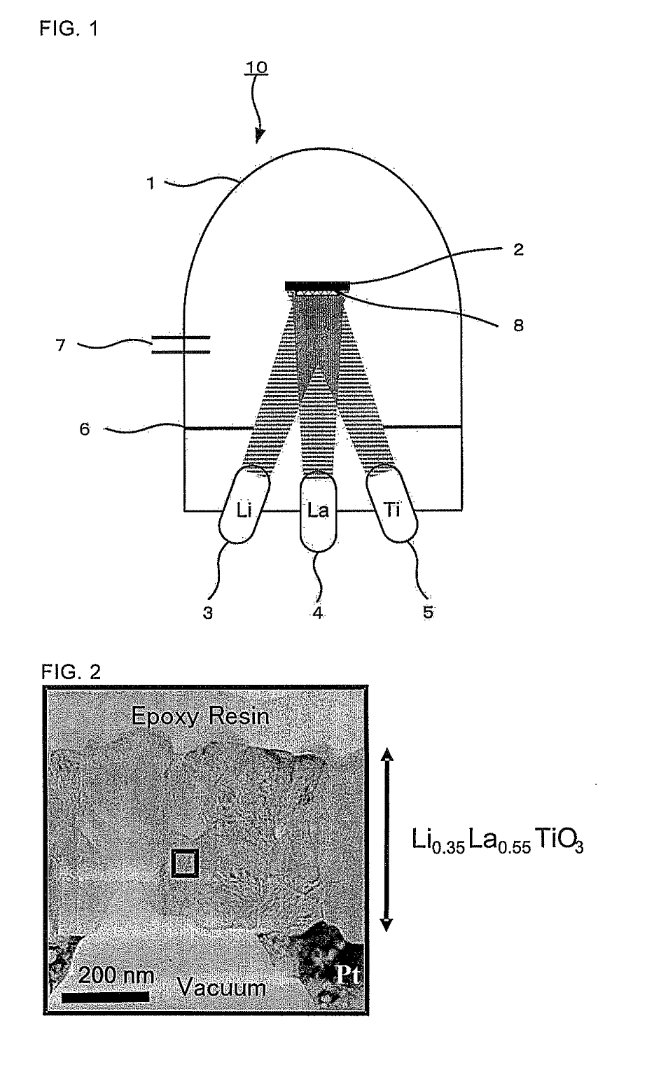

The method for producing a solid electrolyte membrane of the present invention will be explained hereinafter, by use of FIG. 1.

FIG. 1 is a view schematically showing an embodiment of the method for producing a solid electrolyte membrane of the present invention. FIG. 1 shows that chamber 10, of which inside is kept ultrahigh vacuum, has film-forming room 1 and evaporation rooms 3, 4 and 5. Inside film-forming room 1, substrate 2 and O₂ plasma source 7 are disposed.

Evaporation rooms 3, 4 and 5 are Li evaporation room 3, La evaporation room 4 and Ti evaporation room 5, respectively. Li evaporation room 3 is a room for producing lithium in a gas phase state (lithium gas) by heating a lithium metal and thus converting the same into a gas phase (gasification). La evaporation room 4 is a room for producing lanthanum in a gas phase state (lanthanum gas) by heating a lanthanum metal and thus converting the same into a gas phase (gasification). Ti evaporation room 5 is a room for producing titanium in a gas phase state (titanium gas) by heating a titanium metal and thus converting the same into a gas phase (gasification). Each of evaporation rooms 3, 4 and 5 has the following (not shown in FIG. 1): a metal material (vapor deposition material), a crucible for storing the metal material, and a heating source for heating the metal material in the crucible and converting the same into a gas phase.

Film-forming room 1 and evaporation rooms 3, 4 and have a structure which enables communication with each other. Shutter 6 is present between substrate 2 and evaporation rooms 3, 4 and 5, which makes it possible to block the metals in gas phase states produced in evaporation rooms 3, 4 and from moving to substrate 2. An Li₃ₓLa_{2/3-x}TiO₃ thin film can be deposited on substrate by opening shutter 6 so that the metals in gas phase states produced in evaporation rooms 3, 4 and 5 can move to substrate 2 and then reacting the gas phase material with oxygen plasma produced from O₂ plasma source 7 in film-forming room 1.

In the present invention, as described above, an Li₃ₓLa_{2/3-x}TiO₃ (0.05≦x≦0.17) thin film is produced by using as the target at least one of a lithium metal, a lanthanum metal, a titanium metal, a lithium-lanthanum alloy, a lithium-titanium alloy, a lanthanum-titanium alloy and a lithium-lanthanum-titanium alloy, producing a gas phase material containing lithium, lanthanum and titanium, and then reacting the material with oxygen in a single element state.

According to the present invention of such a structure, it is possible to prevent impurities derived from the vapor deposition material (target) from getting mixed into the thin film; therefore, it is possible to prevent gas production (e.g., CO₂) due to the decomposition of impurities associated with the heating of the thin film and thus it is possible to produce a high-density solid electrolyte membrane. According to the present invention, it is possible to obtain a solid electrolyte membrane having a relative density (true density/true density×100%) of 100%.

Moreover, according to the present invention, it is possible to produce a crystalline solid electrolyte membrane; therefore, the solid electrolyte membrane provided by the present invention shows stable ion conductivity even after a heating treatment and so on in a battery production process.

Furthermore, the present invention has an advantage of high productivity because it is not needed to prepare an oxide target.

In addition, it has been confirmed that a solid electrolyte membrane with a high-symmetry crystal grain boundary is obtained by the method for producing a solid electrolyte membrane of the present invention. A thin film with a high-symmetry crystal grain boundary has small crystal grain boundary resistivity, so that is has excellent ion conductivity.

Hereinafter, the steps of the method for producing a solid electrolyte membrane according to the present invention, will be described in detail.

### (Gas Phase Material Production Step)

The gas phase material production step is a step of producing a gas phase material comprising lithium, lanthanum and titanium by converting into a gas phase at least one selected from the group consisting of a lithium metal, a lanthanum metal, a titanium metal, a lithium-lanthanum alloy, a lithium-titanium alloy, a lanthanum-titanium alloy and a lithium-lanthanum-titanium alloy.

The gas phase material comprising lithium, lanthanum and titanium can be only one kind of gas phase metal or a combination of two or more kinds of gas phase metals as long as it comprises lithium, lanthanum and titanium as a whole. For example, “only one kind of gas phase metal” means that the gas phase material comprises only one gas phase metal which contains all of lithium, lanthanum and titanium. “A combination of two or more kinds of gas phase metals” means that the gas phase material is one obtained by combining two or more kinds of gas phase metals so as to contain lithium, lanthanum and titanium, each of the gas phase metals containing at least one of lithium, lanthanum and titanium.

In the gas phase material production step, the metal material used as the vapor deposition material (target) is selected from single metals and alloys. In particular, at least one selected from the group consisting of a lithium metal, a lanthanum metal, a titanium metal, a lithium-lanthanum alloy, a lithium-titanium alloy, a lanthanum-titanium alloy and a lithium-lanthanum-titanium alloy is used as the vapor deposition material. By converting such a single metal and/or alloy into gas phases, it is possible to produce a gas phase metal in a single element state, a binary gas phase metal and/or a ternary gas phase metal, such as lithium in a gas phase state, lanthanum in a gas phase state, titanium in a gas phase state, lithium-lanthanum in s gas phase state, lithium-titanium in a gas phase state, lanthanum-titanium in a gas phase state, and lithium-lanthanum-titanium in a gas-phase state. Then, by reacting such a gas phase metal with oxygen in a single element state, it is possible to prevent impurities from getting mixed into a vapor-deposited film, which is caused by using an oxide as the vapor deposition material.

As long as the thus-produced gas phase material contains lithium, lanthanum and titanium, a lithium metal, a lanthanum metal, a titanium metal, a lithium-lanthanum alloy, a lithium-titanium alloy, a lanthanum-titanium alloy and a lithium-lanthanum-titanium alloy can be used alone or in combination as the vapor deposition material. Preferred combination examples include a combination of a lithium metal, a lanthanum metal and a titanium metal, and a combination of a lithium-titanium alloy and a lithium-lanthanum alloy. Because it is easy to control the composition of the thin film, the combination of a lithium metal, a lanthanum metal and a titanium metal is particularly preferred.

In general, each vapor deposition material can be converted into a gas phase in the state of being stored in a container such as a crucible. The material, shape, etc., of the container can be appropriately selected depending on the type of the vapor deposition material, the method for converting the material into a gas phase, etc. Examples of the material of the container include pyrolytic boron nitride, pyrolytic graphite and platinum.

In the case of using two or more kinds of vapor deposition materials in combination, preferably, they are each separately converted into a gas phase because it is easy to control the composition of the thin film. For example, as described above, in the case of using a combination of a lithium metal, a lanthanum metal and a titanium metal, it is preferable that the lithium metal, lanthanum metal and titanium metal are each separately converted into a gas phase. As just described, by using a lithium metal, a lanthanum metal and a titanium metal and converting each of the materials separately into a gas phase, it is possible to produce lithium, lanthanum and titanium in gas phase states and it is easy to control the composition ratio of lithium, lanthanum and titanium in the gas phase material; therefore, it is easy to form an Li₃ₓLa_{2/3-x}TiO₃ thin film having a desired composition ratio.

In the case of using various types of vapor deposition materials and converting each of the materials separately into a gas phase, a gas phase material can be obtained by mixing gas phase metals produced by converting the vapor deposition materials into gas phases. The method for mixing gas phase metals is not particularly limited. For example, each of the gas phase metals can be moved onto the substrate and mixed thereon.

Preferably, the composition ratio of lithium, lanthanum and titanium in the gas phase material is appropriately determined depending on the composition of Li₃ₓLa_{2/3-x}TiO₃ thin film, the structure of the film-forming apparatus, the pressure applied inside the chamber, etc. This is because, depending on the structure of the film-forming apparatus, the pressure inside the chamber, etc., sometimes all of the lithium, lanthanum and titanium in the gas phase material do not react with the supplied oxygen in a single element state and the composition ratio of the lithium, lanthanum and titanium in the gas phase material is not always consistent with the composition ratio of lithium, lanthanum and titanium in the Li₃ₓLa_{2/3-x}TiO₃ thin film thus formed.

The method for converting the vapor deposition material into a gas phase is not particularly limited.

For example, in the vacuum deposition method, a resistance heating method, electron beam, laser ablation, a high-frequency induction heating method, an arc method or the like can be used as a heating source. A molecular beam epitaxial method can be also used. The heating temperature of the heating source can be appropriately determined depending on the vapor deposition material to be used.

The composition ratio of lithium, lanthanum and titanium in the gas phase material can be controlled by the heating temperature of the heating source. For example, a large amount of lithium can be converted into a gas phase by raising the lithium metal heating temperature, so that the amount of lithium in the gas phase material can be increased. Similarly, the amount of lanthanum in the gas phase material can be increased by raising the lanthanum metal heating temperature, while the amount of titanium in the gas phase material can be increased by raising the titanium metal heating temperature.

In the vacuum deposition method, in order to form an Li₃ₓLa_{2/3-x}TiO₃ thin film having the above composition ratio, the lithium metal heating temperature can be set at about 80 to 180° C., the lanthanum metal heating temperature can be set at about 200 to 920° C., and the titanium metal heating temperature can be set at about 200 to 1,600° C.

In the sputtering method, as the ion generation method, there may be mentioned an ion gun, a glow discharge, etc. Specific methods include a dual sputtering method, a magnetron sputtering method, an electron cyclotron resonance sputtering method and an ion beam sputtering method, for example. In the sputtering method, the composition ratio of lithium, lanthanum and titanium in the gas phase material can be controlled by controlling applied voltage or inner pressure, for example.

In the ion plating method, as the ionization method, there may be mentioned direct current discharge excitation, high frequency discharge excitation, hollow cathode electron beam excitation, etc. In the ion plating method, the composition ratio of lithium, lanthanum and titanium in the gas phase material can be controlled by controlling the pressure of the reactive gas, for example.

In the gas phase material production, the vacuum condition is, for example, preferably 1.0×10⁻² Pa to 1.0×10⁻⁴ Pa or less, more preferably an ultra vacuum condition of 1.0×10⁻⁷ Pa or less.

### (Deposition Step)

The deposition step is a step of depositing an Li₃ₓLa_{2/3-x}TiO₃ (0.05≦x≦0.17) thin film on a substrate by reacting the gas phase material with oxygen in a single element state.

A high-density, crystalline Li₃ₓLa_{2/3-x}TiO₃ (0.05≦x≦0.17) thin film can be obtained by reacting the gas phase material described above with oxygen in a single element state.

In the thin film deposition, the vacuum condition is, for example, as with the gas phase material production, preferably 1.0×10⁻² Pa to 1.0×10⁻⁴ Pa or less, more preferably an ultra vacuum condition of 1.0×10⁻⁷ Pa or less.

Examples of the oxygen in a single element state include oxygen plasma and oxygen molecule. Oxygen plasma can be generated by a general method, such as applying an electric field or external magnetic field.

The ratio of the oxygen in a single element state and gas phase material to be reacted can be appropriately determined, considering the composition ratio of Li₃ₓLa_{2/3-x}TiO₃, etc.

In the deposition step, the substrate on which a thin film will be deposited is preferably heated at a temperature lower than the melting point of lanthanum and that of titanium. In particular, the substrate is heated at a temperature lower than the melting point of lanthanum, 1,727° C., and the melting point of titanium, 887° C. This is because it is thus possible to prevent volatilization of lanthanum and titanium deposited on the substrate by heating the substrate at such a temperature and thus it is possible to form a high-density thin film.

Lithium is an element with a small ionic radius. Accordingly, even if lithium is volatilized from the thin film, there is no decrease in the density of the thin film. Therefore, it is possible to prevent a decrease in the density of the thin film by heating the film at a temperature that is lower than the melting point of lanthanum and that of titanium.

Specifically, the substrate heating temperature is preferably 25 to 800° C., more preferably 50 to 750° C.

The method for heating the substrate is not particularly limited. For example, there may be mentioned a heating method in which the substrate is fixed on a heater and heated by the heater.

The substrate is not particularly limited as long as it is resistant to the above heating temperature and flat and smooth. A member of the battery structure can be used as the substrate, which is adjacent to the solid electrolyte membrane. For example, a member having an electrode active material layer on a surface thereof can be used as the substrate to form the Li₃ₓLa_{2/3-x}TiO₃ thin film on the electrode active material layer.

Specific examples of the substrate include an Si/SiO₂/Ti/Pt laminate (Pt surface is a surface to be vapor-deposited), an Si/SiO₂/TiO₂/Pt laminate, MgO, an Si/SiO₂/TiO₂/Pt/SrRuO₃ laminate, an SiO₂/Pt laminate, and an electrode active material layer.

The distance between the vapor deposition material and the substrate is, for example, preferably about 30 to 700 mm, more preferably about 50 to 500 mm.

The vapor deposition time is not particularly limited and can be appropriately determined depending on the thickness of the solid electrolyte membrane, etc. For example, it is preferably 10 minutes or more and 5 hours or less, more preferably 30 minutes or more and 3 hours or less. If the vapor deposition time is less than 10 minutes, there is a possibility that the thin film thus formed is too thin. If the solid electrolyte membrane is too thin, there is a possibility that a short circuit occurs when vapor-depositing a current collector on the thus-obtained solid polymer electrolyte membrane. If the vapor deposition time is more than 5 hours, there is a possibility that the thin film comes off the substrate. The vapor deposition time starts from the time the material begins to be deposited on the substrate.

### (Heating Step)

The method for producing a solid electrolyte membrane of the present invention is allowed to have the step of heating the thus-obtained thin film after the deposition step. The crystallinity of the Li₃ₓLa_{2/3-x}TiO₃ thin film can be increased by heating.

The atmosphere of the heating step is not particularly limited and can be an oxidative atmosphere or inert atmosphere, for example. Further examples include an air atmosphere, an oxygen atmosphere, an Ar atmosphere and a nitrogen atmosphere.

The heating temperature of the heating step can be appropriately determined. In general, it is preferably 500° C. or more and 1,000° C. or less, more preferably 600° C. or more and 900° C. or less. By setting the heating temperature at 500° C. or more, a sufficient crystallinity increasing effect can be obtained. By setting the temperature at 1,000° C. or less, it is possible to prevent conversion of lithium in the thin film into a gas phase and the resulting change in the composition.

The method for producing a solid electrolyte membrane of the present invention can have a step other than the above-described steps.

The solid electrolyte membrane provided by the present invention is particularly suitable as a component of an electrolyte layer of an all-solid-state battery, especially a lithium battery. Also, it can be suitably used in other batteries.

### EXAMPLES

### Example 1

An Li_{0.35}La_{0.55}TiO₃ thin film was vapor-deposited on a substrate (a Si/SiO₂/Ti/Pt laminate manufactured by Nova Electronic Materials) by physical vapor deposition (PVD) method in the manner described below.

First, a lithium ribbon (manufactured by Sigma Aldrich, 99.9%), lanthanum (manufactured by Sigma Aldrich, 99.9%) and a titanium slag (manufactured by Alfa Aesar, 99.98%) were separately placed inside a chamber kept at an ultrahigh vacuum of 1×10⁻⁸ Pa (1×10⁻¹⁰ mBar) or less. More specifically, the lithium ribbon was put in a crucible made of pyrolytic boron nitride. Each of the lanthanum and the titanium slag was placed in a 40 cm³ crucible made of pyrolytic graphite.

Next, the lithium ribbon in the crucible was heated at 80° C. by resistance heating using Knudsen cells, thereby converting the lithium ribbon into a gas phase. The lanthanum in the crucible was heated at 300° C. with electron beam to be converted into a gas phase, while the titanium slag in the crucible was heated at 400° C. with electron bean to be converted into a gas phase.

Then, a shutter present between the substrate and the vapor deposition materials was opened and lithium gas, lanthanum gas and titanium gas were supplied onto the substrate. Using an oxygen plasma generator (RF source HD25 manufactured by Oxford Applied Research), oxygen plasma was generated inside the PVD chamber and the gas phase material thus obtained was irradiated with the oxygen plasma, thereby vapor-depositing an Li—La—Ti—O thin film on the substrate.

The distance between the substrate and each vapor deposition material was 500 mm. The vapor-deposited area was 0.785 cm². The substrate temperature was 700° C. The vapor deposition time was 60 minutes.

Then, the thus-obtained vapor-deposited film was heated at 750° C. for 3 hours in the air.

The heated vapor-deposited film was subjected to composition analysis, crystalline phase identification, crystal structure observation and ion conductivity measurement. The results are shown in Table 1.

### (Composition Analysis)

The composition of the film was obtained with an inductively-coupled plasma mass spectrometer (ICP-MS) (Elan 9000 manufactured by Perkin Elmer). The composition was Li_{0.35}La_{0.55}TiO₃.

### (Crystalline Phase Identification)

The crystalline phase of the film was identified with an X-ray diffraction (XRD) analyzer (D8 Discover manufactured by Bruker) and found to be perovskite type; therefore, the film was found to be crystalline.

### (Crystal Structure Observation)

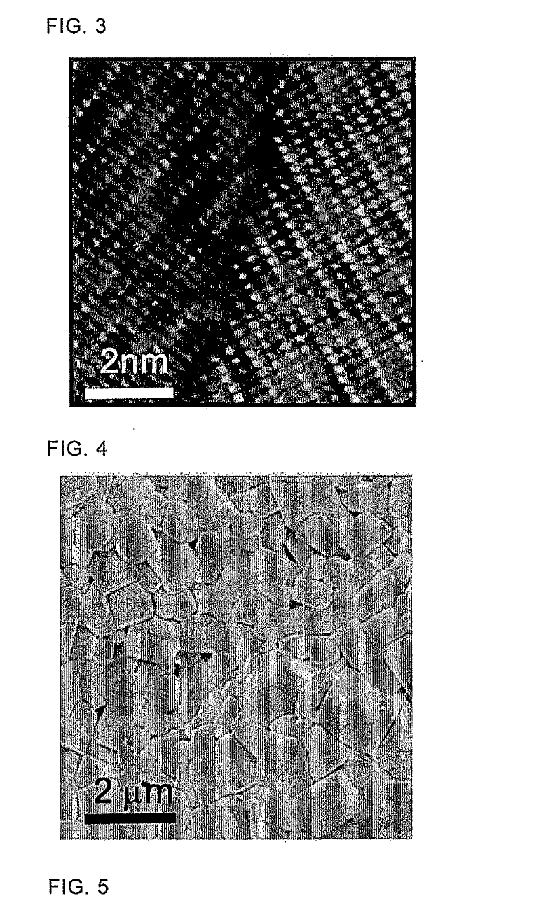

Crystal structure observation was carried out with a transmission electron microscope (TEM). The results are shown in FIGS. 2 and 3. Pt is a component derived from the substrate. Epoxy resin is a component derived from the material used in a sampling process for TEM observation.

It was confirmed from FIG. 2 that there are no holes inside the thin film and the relative density is 100%.

FIG. 3 is an enlarged TEM photograph of a crystal grain boundary in FIG. 2 (a boxed area shown in FIG. 2). It was confirmed from FIG. 3 that the right and left crystal grain alignments are symmetric about the crystal grain boundary.

### (Ion Conductivity Measurement)

Ion conductivity measurement was carried out under the following condition, using an alternate current (AC) impedance measuring apparatus (Model 1260 manufactured by Solartron). The result was 2.1×10⁻⁴ S/cm.

Frequency range: 500 kHz to 1 Hz

AC amplitude: 100 mV

### Example 2

An Li—La—Ti—O thin film was vapor-deposited in the same manner as Example 1, except that the lithium heating temperature by resistance heating was changed to 90° C.; the lanthanum heating temperature with electron beam was changed to 280° C.; and the titanium heating temperature with electron beam was changed to 380° C. The thus-obtained vapor-deposited film was heated at 750° C. for 3 hours in the air.

In the same manner as Example 1, the heated vapor-deposited film was subjected to composition analysis, crystalline phase identification, crystal structure observation and ion conductivity measurement. The results are shown in Table 1.

### (Composition Analysis)

The composition of the film was obtained with the inductively-coupled plasma mass spectrometer (ICP-MS). The composition was Li_{0.40}La_{0.53}TiO₃.

### (Crystalline Phase Identification)

The crystalline phase of the film was identified with the X-ray diffraction (XRD) analyzer and found to be perovskite type; therefore, the film was found to be crystalline.

### (Crystal Structure Observation)

Crystal structure observation was carried out with the transmission electron microscope (TEM). It was confirmed that there are no holes inside the thin film and the relative density is 100%.

### (Ion Conductivity Measurement)

Ion conductivity measurement was carried out with the AC impedance measuring apparatus. The result was 1.6×10⁻⁴ S/cm.

TABLE 1

| | | Substrate | Melting Point of | Evaluation Results | | |
|---|---|---|---|---|---|---|
| | | Temperature | Constituent | Crystal | Relative | Ion Conductivity |
| | Composition | (° C.) | Elements (° C.) | Structure | Density | (S/cm) |
| Example 1 | Li_{0.35}La_{0.55}TiO₃ | 700 | La: 887° C. | Perovskite | 100% | 2.1 × 10⁻⁴ |
| | | | Ti: 1,727° C. | type | | |
| Example 2 | Li_{0.40}La_{0.53}TiO₃ | 700 | La: 887° C. | Perovskite | 100% | 1.6 × 10⁻⁴ |
| | | | Ti: 1,727° C. | type | | |

As shown in Table 1, the method for producing a solid electrolyte membrane of the present invention can produce a high-density, crystalline Li₃ₓLa_{2/3-x}TiO₃ thin film. This is considered to be because: the film has high relative density and thus high density; the crystal grain alignments are symmetric about the crystal grain boundary (see FIG. 3); and the film has low crystal grain boundary resistivity.

### Comparative Example 1

A Li_{0.35}La_{0.55}TiO₃ sintered body was obtained in the following manner. First, Li₂CO₃ (manufactured by Kishida Chemical Co., Ltd., purity 3N), La₂O₃ (manufactured by Kishida Chemical Co., Ltd., purity 4N) and TiO₂ (manufactured by Sigma Aldrich, purity 3N) were weighed so as to be Li:La:Ti=0.35:0.55:3 (molar ratio) and mixed with an agate mortar. Then, the thus-obtained mixed powder was calcined at 800° C. for one hour and then at 1,100° C. for 12 hours in the air atmosphere. Then, the thus-obtained calcined powder was pelletized at a pressure of 240 MPa and sintered at 1,175° C. for 12 hours in the air atmosphere, followed by furnace cooling, thereby obtaining an Li_{0.35}La_{0.55}TiO₃ sintered body.

Ion conductivity measurement was carried out on the thus-obtained sintered body in the same manner as Example 1. The result was 1.3×10⁻⁵ S/cm. It is shown in Table 2.

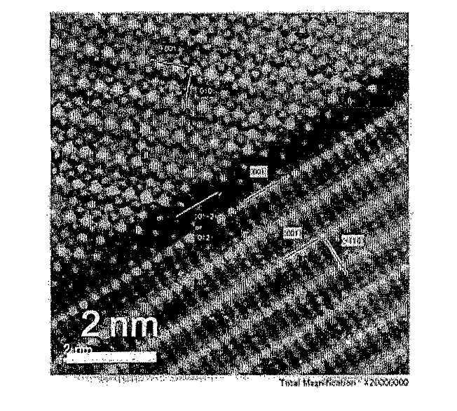

Crystal structure observation was carried out on the thus-obtained sintered body with an scanning electron microscope (SEM) and transmission electron microscope (TEM). The results are shown in FIG. 4 (SEM) and FIG. 5 (TEM).

As shown in FIG. 4, it was confirmed that in the sintered body of Comparative Example 1, holes are present in the crystal grain boundary, so that the relative density is lower than 100%. It was confirmed from FIG. 5, which is an enlarged photograph of the crystal grain boundary, that the symmetry of the upper and lower crystal grain alignments about the crystal grain boundary is lower than Example 1.

### Comparative Example

An Li_{0.40}La_{0.53}TiO₃ sintered body was obtained in the following manner. It was obtained in the same manner as Comparative Example 1, except that Li₂ CO₃ (manufactured by Kishida Chemical Co., Ltd., purity 3N), La₂O₃ (manufactured by Kishida Chemical Co., Ltd., purity 4N) and TiO₂(manufactured by Sigma Aldrich, purity 3N) were weighed so as to be Li:La:Ti=0.40:0.53:3 (molar ratio).

Ion conductivity measurement was carried out on the thus-obtained sintered body in the same manner as Example 1. The result was 2.2×10⁻⁵ S/cm. It is shown in Table 2.

TABLE 2

| | Examples | Comparative Examples | Reference Examples |
|---|---|---|---|
| Composition | (Crystalline Thin Film) | (Sintered Body) | (Non-crystalline Thin Film) |
| Li_{0.35}La_{0.55}TiO₃ | (Example 1) | (Comparative Example 1) | 1 × 10⁻⁶ S/cm |
| | 2.0 × 10⁻⁴ S/cm | 1.3 × 10⁻⁵ S/cm | |
| Li_{0.40}La_{0.53}TiO₃ | (Example 2) | (Comparative Example 2) | 6.7 × 10⁻⁶ S/cm |
| | 1.6 × 10⁻⁴ S/cm | 2.2 × 10⁻⁵ S/cm | |

Table 2 also shows the ion conductivities of the crystalline thin films of Examples 1 and 2, along with the following ion conductivities as reference examples: the ion conductivity of an Li_{0.35}La_{0.55}TiO₃ non-crystalline thin film described in Patent Literature 1 (Sample 102 of Patent Literature 1) and the ion conductivity of an Li_{0.40}La_{0.53}TiO₃ non-crystalline thin film described in the same (Sample 9 of Patent Literature 1).

As is clear from Table 2, the Li₃ₓLa_{2/3-x}TiO₃ thin films obtained by the production method of the present invention (Examples 1 and 2) show excellent ion conductivity, compared to the sintered bodies (Comparative Examples 1 and 2) and the non-crystalline thin films (Reference Examples, non-crystalline thin films according to Patent Literature 1), each of the comparative and reference examples having the same composition as Example 1 or 2.

According to a comparison between Example 1 and Comparative Example 1, while holes are present in the crystal grain boundary (see FIG. 4) and the symmetry of the crystal grain alignments about the crystal grain boundary is low (see FIG. 5) in Comparative Example 1, no holes are present inside the thin film (see FIG. 2) and the symmetry of the crystal grain alignments about the crystal grain boundary is high (see FIG. 3) in Example 1. Therefore, it is considered that Example 1 showed significantly higher ion conductivity than Comparative Example 1.

### REFERENCE SIGNS LIST

1. Film-forming room
2. Substrate
3. Li evaporation room
4. La evaporation room
5. Ti evaporation room
6. Shutter
7. O₂ plasma source
8. Li₃ₓLa_{2/3-x}TiO₃ thin film
10. Ultrahigh vacuum chamber

1. A method for producing a solid electrolyte membrane which comprises a solid electrolyte described by the composition formula Li3xLa2/3-xTiO3 (0.05≦x≦0.17), the method comprising the steps of:
producing a gas phase material comprising lithium, lanthanum and titanium by converting into a gas phase at least one selected from the group consisting of a lithium metal, a lanthanum metal, a titanium metal, a lithium-lanthanum alloy, a lithium-titanium alloy, a lanthanum-titanium alloy and a lithium-lanthanum-titanium alloy, and
depositing an Li3xLa2/3-xTiO3 (0.05≦x≦0.17) thin film on a substrate by a gas phase method for reacting the gas phase material with oxygen in a single element state.

2. The method for producing a solid electrolyte membrane according to claim 1, wherein the substrate is heated at a temperature lower than the melting point of lanthanum and that of titanium in the deposition step.

3. The method for producing a solid electrolyte membrane according to claim 1, further comprising a step of heating the Li3xLa2/3-xTiO3 thin film after the deposition step.

4. The method for producing a solid electrolyte membrane according to claim 3, wherein the Li3xLa2/3-xTiO3 thin film is heated at 500 to 1,000° C. in the heating step.

5. The method for producing a solid electrolyte membrane according to claim 1, wherein the lithium metal, lanthanum metal and titanium metal are each separately converted into a gas phase to produce lithium, lanthanum and titanium in gas phase states in the gas phase material production step.

6. The method for producing a solid electrolyte membrane according to claim 5, wherein the lithium, lanthanum and the titanium in gas phase states are reacted with the oxygen in a single element state in the deposition step.

7. The method for producing a solid electrolyte membrane according to claim 1, wherein the oxygen in a single element state in the deposition step is oxygen plasma.
